(19) United States
(12) Patent Application Publication
(10) Pub. No.: US 2004/0054665 A1
(43) Pub. Date: Mar. 18, 2004

(54) Apparatus for sharing and storing mass video data in video geographic information system and management method thereof

(76) Inventors: Jae Jun Yoo, Seoul (KR); Jong Hun Lee, Seoul (KR); Kwang Woo Nam, Cheongju (KR); In Hak Joo, Taejon (KR); Jong Hyun Park, Taejon (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 10/359,709

(22) Filed: Feb. 7, 2003

(30) Foreign Application Priority Data
Sep. 12, 2002 (KR) 2002 - 55197

(51) Int. Cl. G06F 17/30

(52) U.S. Cl. 707/3

(57) ABSTRACT

There is provided an apparatus for sharing and storing mass video data in a video geographic information system, and providing a usage of spatial indices for shared and stored information, and quick search for databases, the apparatus including: a map viewer for searching and outputting spatial geographic information; a video viewer for searching and outputting video data; a mass video data share, storage and management component for communicating with the map viewer and the video viewer, sharing and storing mass video data, which is not suitable for a storage in a single database, into a plurality of databases, and managing the plurality of databases to be accessible, integrated-searchable and manageable just like a single database; and a server including a share and storage information database for actually sharing and storing video data, which is managed by the mass video data share, storage and management component, offering a search, change, and management for each shared and stored data, and allowing to store and search the shared and stored information data; a plurality of video databases for storing and searching video data; and a spatial geographic database for storing and searching spatial geographic information corresponding to video data.

### BACKGROUND OF THE INVENTION

1. Field of the Invention

The present invention relates to a video geographic information system (GIS) for providing moving or static images data associated with spatial geographic information to show and supply spatial geographic information much more realistically, and more particularly, to an apparatus for sharing and storing mass video data, being in volume too large to be stored in a single system, and making them integrated-searchable and manageable in a video geographic information system, and a management method thereof.

2. Discussion of the Related Art

Generally, a conventional video geographic information system does not provide means for sharing and storing, integrated-searching, and managing vast quantities of video data which cannot be stored in a single system, and therefore, there is a limitation in volume of video data which is possibly shown with associated with other information in the video geographic information system.

### SUMMARY OF THE INVENTION

Accordingly, the present invention is directed to a video geographic information system that substantially obviates one or more problems due to limitations and disadvantages of the related art.

An object of the present invention is to provide an apparatus for providing processing including, for example, sharing and storing, integrated-searching and changing vast quantities of video data, being unsuitable for a storage in a single system, into a plurality of video databases in a video geographic information system, and a management method thereof.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for sharing and storing mass video data in a video geographic information system, the apparatus comprising: a map viewer for searching and outputting spatial geographic information; a video viewer for searching and outputting video data; a mass video data share, storage and management component for communicating with the map viewer and the video viewer, sharing and storing mass video data, which is not suitable for a storage in a single database, into a plurality of databases, and managing the plurality of databases to be accessible, integrated-searchable and manageable just like a single database; and a server including a share and storage information database for actually sharing and storing video data, which is managed by the mass video data share, storage and management component, offering a search, change, and management for each shared and stored data, and allowing to store and search the shared and stored information data; a plurality of video databases for storing and searching video data; and a spatial geographic database for storing and searching spatial geographic information corresponding to video data.

According to another aspect of the present invention, there is provided a method for sharing, storing and managing mass video data in a video geographic information system, which is characterized in establishing database by sharing and storing mass video data corresponding to spatial geographic information, the method comprising the steps of achieving video data corresponding to spatial geographic information, which a mass video data share, storage and management component is to establish; dividing the achieved video data, and determining a database being used to store each video data according to achieved location information of corresponding video data; separating the video data to be stored, and transmitting to and storing in each video database; and changing the share and storage information database by adding share and storage information including the achieved location information of newly-stored video data.

According to another aspect of the present invention, there is provided a method for sharing, storing and managing mass video data in a video geographic information system, which is characterized in searching mass video data corresponding to shared and stored spatial geographic information, the method comprising the steps of: a mass video data share, store and management component's achieving search query and condition for video data corresponding to spatial geographic information to be searched, from a map viewer and a video viewer through a share and storage component interface; determining video database to be searched by referring to the achieved search query and condition, and the share and storage information database; searching each video database, and establishing plans for post-process to be performed to achieve the same result as in a single database; separating queries to be performed in each video database; transmitting the separated query to each video database to perform query, bringing the performed result back, and performing the post-process for the performed result of the separated query; and changing share and storage information database to update with additional information of statistical information for search query.

According to another aspect of the present invention, there is provided a method for sharing, storing and managing mass video data in a video geographic information system, which is characterized in changing mass video data corresponding to shared and stored spatial geographic information, the method comprising the steps of a mass video data share, storage and management component's achieving query and condition for video data corresponding to spatial geographic information to be changed from a map viewer and a video viewer; determining video database, which stores the video data to be changed, by referring to share and storage information; separating content to be changed from the determined video database; changing the separated video data, and storing again; and changing the share and storage information database by adding share and storage information of the changed video data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an apparatus for sharing and storing mass video data in a video geographic information system according to the present invention;

FIG. 2 is an exemplary view of sharing and storing video data and spatial geographic information in an apparatus for sharing and storing mass video data according to the present invention;

FIG. 3 is an ER data exemplary view of storing share and storage information into database in an apparatus for sharing and storing mass video data according to the present invention;

FIG. 4 is a flow chart of a method for sharing and storing video data and spatial geographic information in an apparatus for sharing and storing mass video data of a video geographic information system according to the present invention;

FIG. 5 is a flow chart of a method for searching video data and spatial geographic information in an apparatus for sharing and storing mass video data of a video geographic information system according to the present invention;

FIG. 6 is a flow chart of a method for changing video data and spatial geographic information in an apparatus for sharing and storing mass video data of a video geographic information system according to the present invention; and

FIG. 7 illustrates an operation state of an apparatus for sharing and storing mass video data of a video geographic information system according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

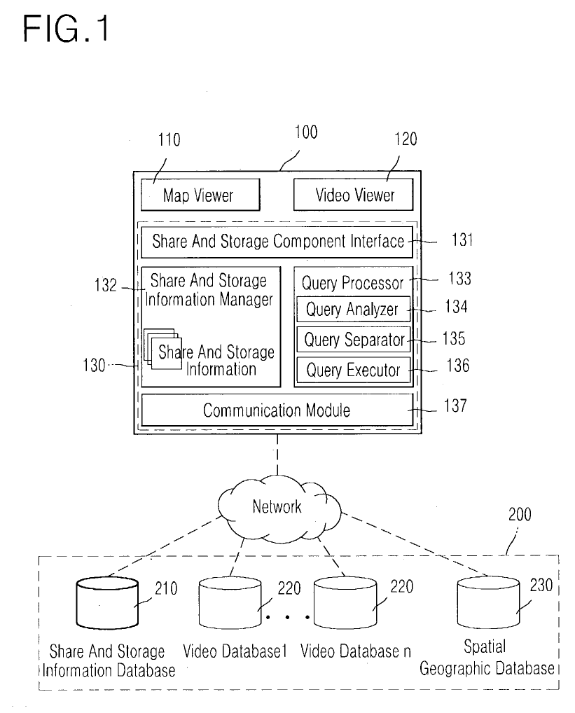

Referring to FIGS. 1 to 3, an apparatus for sharing and storing mass video data in a video geographic information system of the present invention is figured to include a client 100 having a map viewer 110, a video viewer 120, and a mass video data share, storage and management component 130; and a server 200.

The map viewer 110 enables a user to search and output spatial geographic information. The video viewer 120 enables a user to search and output video data.

The mass video data share, storage and management component 130 communicates the map viewer 110 and the video viewer 120, shares and stores mass video data, which cannot be stored in a single database, into a plurality of databases, and then, controls to access to, integrated-search, and manage the plurality of databases such that the databases can be treated as a single database.

The share and storage component interface 131 of the mass video data share, storage and management component 130 enables the map viewer 110 and the video viewer 120 to access to the component 130 through one common interface.

A share and store information manager 132 of the mass video data share, storage and management component 130 stores and manages the share and storage information of video data corresponding to spatial geographic information.

A query processor 133 of the mass video data share, storage and management component 130 processes queries associated with video data from the map viewer 110 and the video viewer 120.

A query analyzer 134 of the query processor 133 refers share and storage information and determines a video database 220 for the query to be actually performed on. Then, the query analyzer 134 collects the performed results in each video database 220, and makes the plans for post-process for achieving the same results as that in a single database.

A query separator 135 of the query processor 133 separates query according to the analyzed result of the query by the query analyzer 134 such that a corresponding query is processed in each video database.

A query executor 136 of the query processor 133 transmits each query separated by the query separator 135 to a corresponding video database 220, and performs the post-process plan from the query analyzer 134 to achieve final results.

A communication module 137 of the mass video data share, storage and management component 130 transmits query and performed results of the query between the elements of the client 100, and the databases 210, 220, 230 of the server 200.

The server 200 shares and stores actual video data, which is managed by the mass video data share, storage and management component 130, and provides search, change, and management for each of the data, which is shared and stored.

The server 200 includes the share and storage information database 210 for allowing to store and search the shared and stored information, the plurality of video databases 220 for allowing to store and search video data, and the spatial geographic database 230 for allowing to store and search spatial geographic information corresponding to the video data.

The original video data is shared and stored in the plurality of video databases 220 in consideration of neighboring locations of video data, and whether or not to store a specific video data in a specific video database 220.

The share and storage information database 210 stores and maintains only achieved location information of the video data stored in each video database 220 as least share and storage information of the video data with an identifier of video data and an identifier of the video database 220 in order to share and store the video data corresponding to spatial geographic information in each video database 220, and accordingly, the size limitation of the data, which cannot be stored in a single system, is obviated, and quick search for the storage location of each data is provided by using indices.

The achieved location information of video data included in the share and storage information is represented as a shape of MBR or line string for the area shown by the video data.

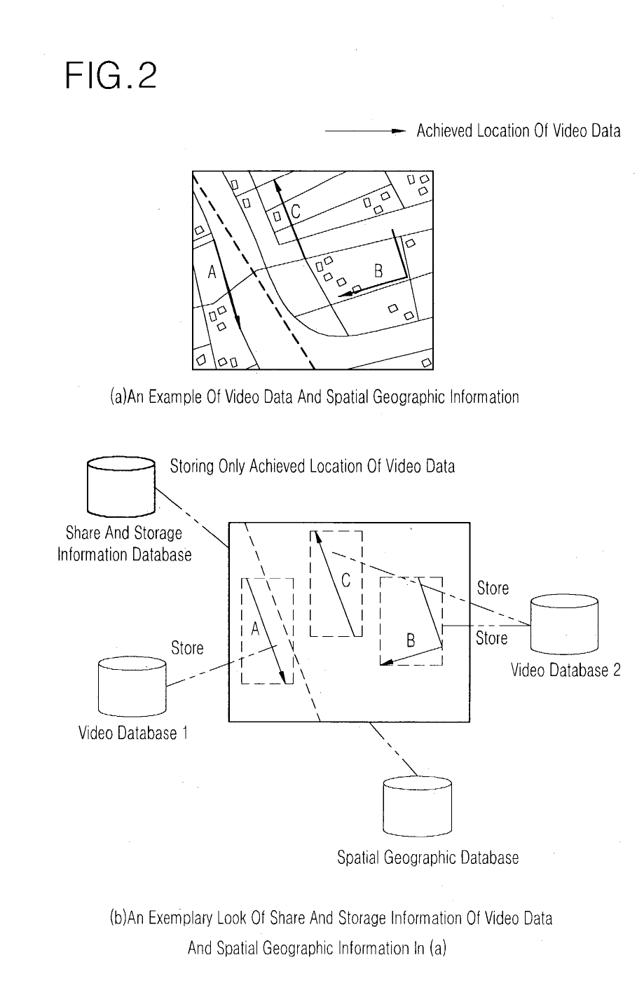

Actually, as shown in FIGS. 2(a) and (b), the video data A, B, C to be shared and stored corresponding to spatial geographic information represents each location information as MBR, and if sharing and storing the video data A, B, C, the share and storage information database 210 stores the achieved location information of video data as MBR with an identifier of video data and an identifier of the video database 220 to record share and store information of video data. In addition, the share and store information database 210 for storing and managing the share and storage information provides a search for an actual database identifier, etc. which stores video data for a specific location.

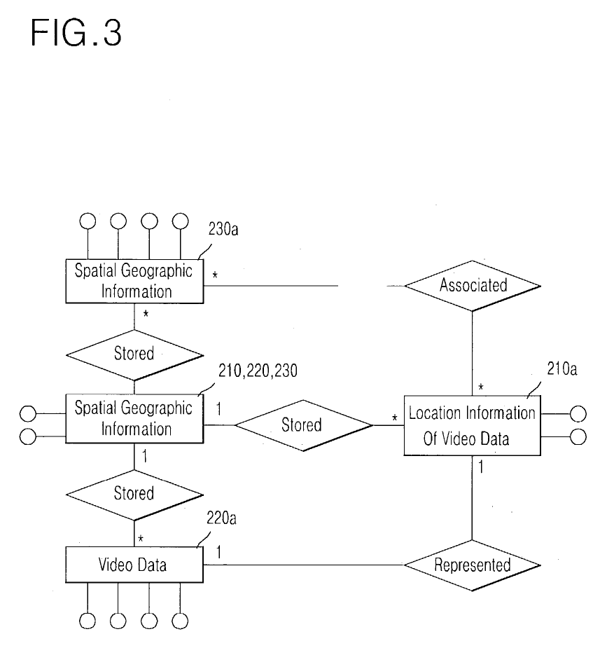

As shown in FIG. 3, referring to ER data model prepared for efficient share and storage of video data corresponding to spatial geographic information, the location information 210a of achieved video data in the present invention is represented as MBR, a line string or space such as polygon, etc. in order to share and store video data. Such information is stored in the share and storage information database 210, and separated spatial geographic information 230a and the video data 220a are stored in the spatial geographic database 230 and the video database 220 respectively. In addition, in the present invention, schema of table for storing share and storage information is prepared based on the model of FIG. 3.

The apparatus for sharing and storing mass video data in a video geographic information system structured as above according to the present invention operates as follows.

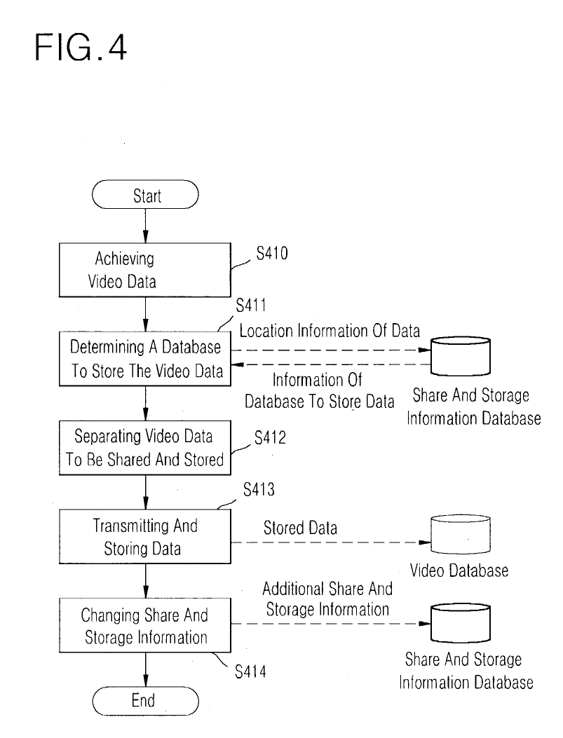

Referring to FIG. 4, the apparatus for sharing and storing mass video data of the present invention shares and stores mass video data corresponding to spatial geographic information to establish a database.

The component 130 of the client 100 achieves video data corresponding to spatial geographic information from the map viewer 110 and the video viewer 120 through the share and storage component interface 131 (S410), divides the achieved video data, and determines a database for storing each video data in accordance with the achieved location information of the corresponding video data (S411).

Then, the component 130 divides the video data being stored (S412), transmits and stores in each video database 220 (S413), and changes the share and storage information database 210 by adding the share and storage information including the achieved location information of the newly-stored video data (S414) so as to establish a database by sharing and storing mass video data corresponding to spatial geographic information.

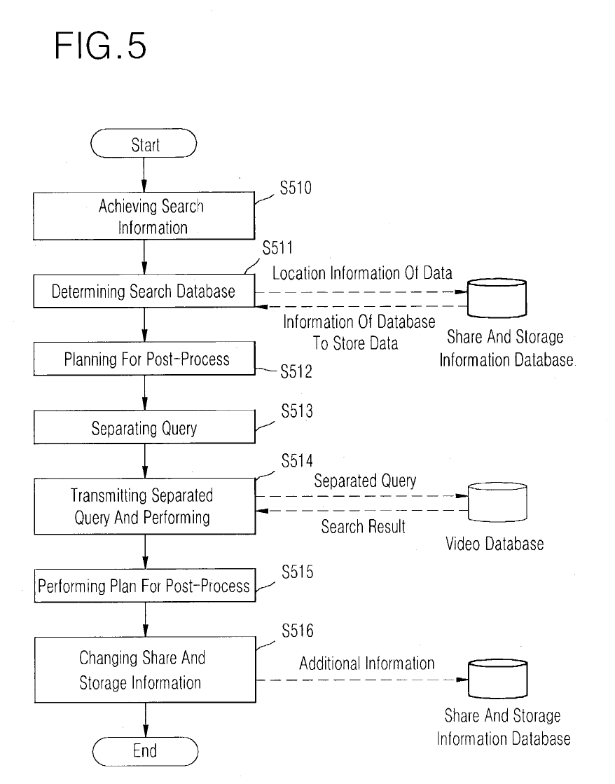

Referring to FIG. 5, the apparatus for sharing and storing mass video data of the present invention searches mass video data corresponding to the spatial geographic information which is shared and stored.

The component 130 of the client 100 achieves search query and condition for video data corresponding to spatial geographic information to be searched, from the map viewer 110 and the video viewer 120 through the share and storage component interface 131 (S510).

Then, the component 130 determines which video database to select for a search in the plurality of the video databases 220, by referring to the achieved search query and condition, and the achieved location information which is included in the share and storage information of the share and storage information database 210 (S511), searches each video database 220, and establishes plans to perform for post-process to achieve the same results as in a single database (S512).

Providing that the plans for post-process are established as above, the component 130 divides the query to be performed at each video database 220 (S513), transmits each divided query to the respective video database 220 to perform the query, brings the performed results back (S514), and performs the post-process plan for the performed results of the divided query (S515). After performing the post-process plan, finally, the component 130 searches mass video data corresponding to the shared and stored spatial geographic information, by changing the share and storage information database 210 so as to update additional information for statistical information, etc. for the search query.

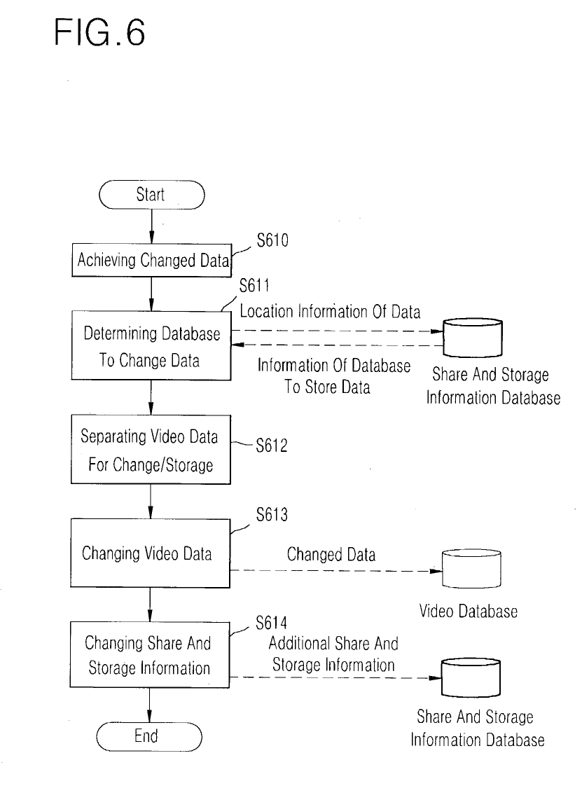

Referring to FIG. 6, the apparatus for sharing and storing mass video data of the present invention changes mass video data corresponding to shared and stored spatial geographic information.

Then, the component 130 of the client 100 achieves search query and condition for video data corresponding to spatial geographic information to be changed, from the map viewer 110 and the video viewer 120 through the share and storage component interface 131 (S610), and determines a video database 220 having the video, data to be changed therein, by referring to the share and storage information (S611).

Then, the component 130 separates the content to be changed from the determined video database 220 (S612), changes the separated video data and stores again (S613), and adds the share and storage information of the changed video data so as to change the share and storage information database 210 (S614), resulting in mass video data corresponding to the shared and stored spatial geographic information being changed.

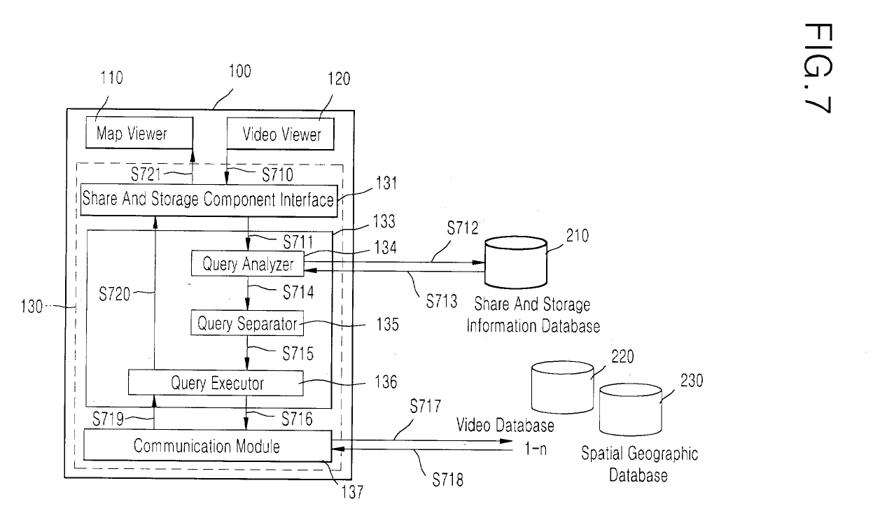

Referring to FIG. 7, a detailed description will be made on how to operate the component 130 of the client 100, and the databases 210, 220, 230 of the server 200 in the apparatus for sharing and storing mass video data of the present invention in order to share and store, allow an integrated-search, and change mass video data as follows.

First, if a query for adding, searching, changing, and outputting video data is transmitted from the map viewer 110 and the video viewer 120 through the share and storage component interface 131 to the component 130 (S710), and the query is transmitted to the query analyzer 134 of the query processor 133 (S711).

According thereto, the query analyzer 134 refers the share and storage information database 210 to determine the video database 220 being referred to perform a query (S712), and first, determines the video database to perform the query, and plans for post-process to achieve final results after performing each query at the respective video database 220 (S713), and transmits to the query separator 135 (S714).

Then, the query separator 135 separates the query by using the share and storage information achieved from the query analyzer 134 such that each video database 220 performs the query, and transmits the separated query and the post-process plan to the query executor 136 (S715).

The query executor 136 transmits the separated query to each video database 220 and the spatial geographic database 230 through the communication module 137 (S716, S717) to perform the query. The performed result of the query is transmitted to the query executor 136 through the communication module 137 (S718, S719).

The query executor 136, which received the performed result of the query, performs the post-process plan prepared by the query analyzer 134, for the performed result of the separated query and transmits the final results to the map viewer 110 and the video viewer 120 through the share and storage component interface 131 (S720, S721).

By the processes set forth before, the map viewer 110 and the video viewer 120 of the apparatus for sharing and storing mass video data according to the present invention, uses mass video data as if it is stored in a single database even though the mass video data is not actually suitable for a storage in a single database.

As described above, an apparatus for sharing and storing mass video data in a video geographic information system, and a management method thereof according to the present invention, allows mass video data, being not suitable to be stored in a single database, to be shared and stored in a plurality of databases, and to be integrated-searchable and manageable such that the plurality of databases are viewed as a single database, which provides advantages of allowing a use of spatial indices for shared and stored information, and a quick search for stored databases.

The above embodiment is just one example of an apparatus for sharing and storing mass video data in a video geographic information system, and a management method thereof according to the present invention, and it will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for sharing and storing mass video data in a video geographic information system, the apparatus comprising:
a map viewer for searching and outputting spatial geographic information;
a video viewer for searching and outputting video data;
a mass video data share, storage and management component for communicating with the map viewer and the video viewer, sharing and storing mass video data, which is not suitable for a storage in a single database, into a plurality of databases, and managing the plurality of databases to be accessible, integrated-searchable and manageable just like a single database; and
a server including a share and storage information database for actually sharing and storing video data, which is managed by the mass video data share, storage and management component, offering a search, change, and management for each shared and stored data, and allowing to store and search the shared and stored information data; a plurality of video databases for storing and searching video data; and a spatial geographic database for storing and searching spatial geographic information corresponding to video data.

2. The apparatus for sharing and storing mass video data of claim 1, wherein the share and storage information database stores only achieved location information of video data stored in each video database along with identifier of the video data and identifier of the video database as share and storage information of the video data in order to share and store video data corresponding to spatial geographic information in each video database.

3. The apparatus for sharing and storing mass video data of claim 1, wherein the map viewer, the video viewer, and mass video data share and storage management component are a client corresponding to the server.

4. The apparatus for sharing and storing mass video data of claim 1, wherein the mass video data share, storage and management component comprises:
a share and storage component interface enabling the map viewer and the video viewer to be accessible to the component through one common interface;
a share and storage information manager for storing and managing share and storage information of the video data corresponding to the spatial geographic information;
a query processor for processing video data-related query from the map viewer and the video viewer; and
a communication module for transmitting query and performed result of the query between the elements of the client and the databases of the server.

5. The apparatus for sharing and storing mass video data of claim 3, wherein the mass video data share, storage and management component comprises:
a share and storage component interface enabling the map viewer and the video viewer to be accessible to the component through one common interface;
a share and storage information manager for storing and managing share and storage information of the video data corresponding to the spatial geographic information;
a query processor for processing video data-related query from the map viewer and the video viewer; and
a communication module for transmitting query and performed result of the query between the elements of the client and the databases of the server.

6. The apparatus for sharing and storing mass video data of claim 4, wherein the query processor comprises:
a query analyzer for determining video database for query to be actually performed on by referring to the share and storage information, collecting the performed result in each database, and planning for post-process for achieving the same results as in a single database;
a query separator for separating query such that a corresponding query is processed in each video database according to query analysis result by the query analyzer; and
a query executor for transmitting each query separated by the query separator to corresponding video database to perform the query, and performing the post-process achieved from the query analyzer to achieve final results.

7. The apparatus for sharing and storing mass video data of claim 5, wherein the query processor comprises:
a query analyzer for determining video database for query to be actually performed on by referring to the share and storage information, collecting the performed result in each database, and planning for post-process for achieving the same results as in a single database;
a query separator for separating query such that a corresponding query is processed in each video database according to query analysis result by the query analyzer; and
a query executor for transmitting each query separated by the query separator to corresponding video database to perform the query, and performing the post-process achieved from the query analyzer to achieve final results.

8. A method for sharing, storing and managing mass video data in a video geographic information system, which is characterized in establishing database by sharing and storing mass video data corresponding to spatial geographic information, the method comprising the steps of:
a) achieving video data corresponding to spatial geographic information, which a mass video data share, storage and management component is to establish;
b) dividing the achieved video data, and determining a database being used to store each video data according to achieved location information of corresponding video data;
c) separating the video data to be stored, and transmitting to and storing in each video database; and
d) changing the share and storage information database by adding share and storage information including the achieved location information of newly-stored video data.

9. A method for sharing, storing and managing mass video data in a video geographic information system, which is characterized in searching mass video data corresponding to shared and stored spatial geographic information, the method comprising the steps of:
a) a mass video data share, store and management component's achieving search query and condition for video data corresponding to spatial geographic information to be searched, from a map viewer and a video viewer through a share and storage component interface;
b) determining video database to be searched by referring to the achieved search query and condition, and the share and storage information database;
c) searching each video database, and establishing plans for post-process to be performed to achieve the same result as in a single database;
d) separating queries to be performed in each video database;
e) transmitting the separated query to each video database to perform query, bringing the performed result back, and performing the post-process for the performed result of the separated query; and
f) changing share and storage information database to update with additional information of statistical information for search query.

10. A method for sharing, storing and managing mass video data in a video geographic information system, which is characterized in changing mass video data corresponding to shared and stored spatial geographic information, the method comprising the steps of:
a) a mass video data share, storage and management component's achieving query and condition for video data corresponding to spatial geographic information to be changed from a map viewer and a video viewer;
b) determining video database, which stores the video data to be changed, by referring to share and storage information;
c) separating content to be changed from the determined video database;
d) changing the separated video data, and storing again; and
e) changing the share and storage information database by adding share and storage information of the changed video data.
